(19) United States
(12) Patent Application Publication
(10) Pub. No.: US 2017/0205823 A1
(43) Pub. Date: Jul. 20, 2017

(54) METHOD AND DEVICE FOR OPERATING A MOTOR VEHICLE

(71) Applicant: FORD GLOBAL TECHNOLOGIES, LLC

(72) Inventors: Christoph ARNDT, Moerlen Rheinland-Pfalz (DE); Frederic STEFAN, Aachen (DE); Uwe GUSSEN, Huertgenwald (DE)

(73) Assignee: FORD GLOBAL TECHNOLOGIES, LLC, Dearborn, MI (US)

(21) Appl. No.: 15/407,993

(22) Filed: Jan. 17, 2017

(30) Foreign Application Priority Data
Jan. 18, 2016 (DE) 10 2016 200 513.8

(51) Int. Cl. G05D 1/00; B60Q 5/00; G01C 21/36; G05D 1/02; B60N 2/02

(52) U.S. Cl. CPC G05D 1/0061; G05D 1/021; B60N 2/0276; G01C 21/3691; B60Q 5/005; B60N 2002/0272; B60K 28/02

(57) ABSTRACT

The disclosure relates to a method and a device for operating a motor vehicle. The vehicle exhibits a first driving mode in which an at least partial automation of the control of the vehicle is obtained. The vehicle also exhibits a second driving mode in which the automation has been at least partly canceled and replaced by a manual control of the vehicle on the part of a driver. The method for operating the motor vehicle comprises the following steps: ascertaining at least one parameter that is characteristic of a current status of the driver, and adapting a transition strategy for the transition between the first driving mode and the second driving mode in a manner depending on the parameter.

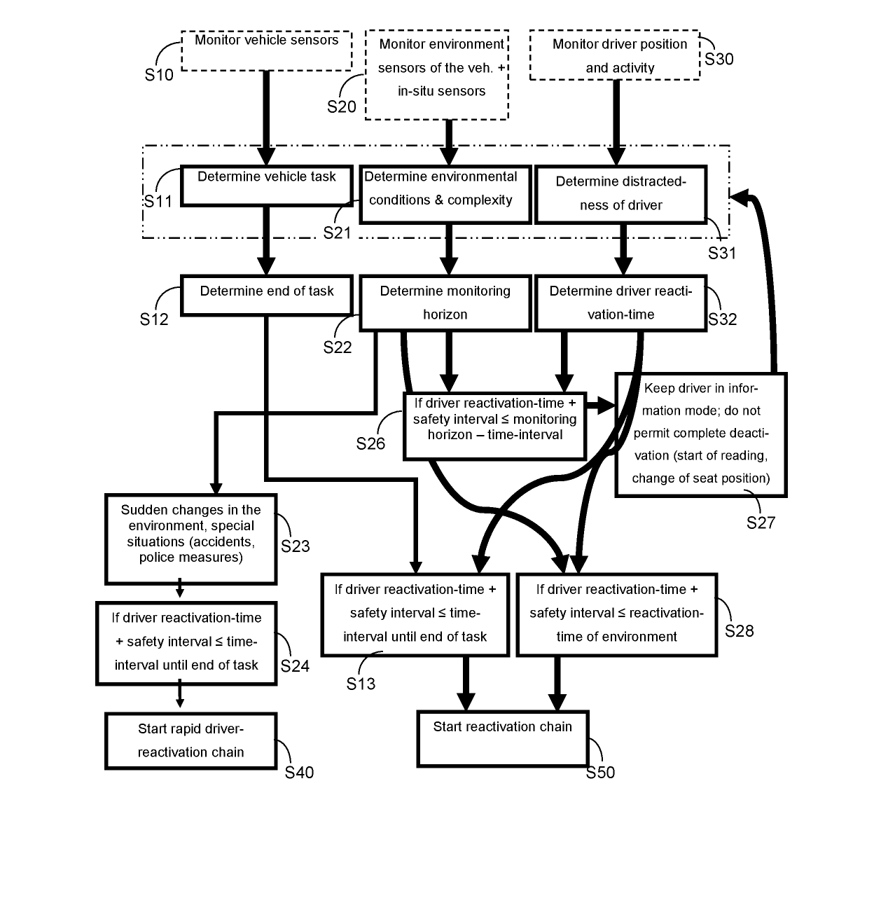

### CROSS-REFERENCE TO RELATED APPLICATIONS

This application claims foreign priority benefits under 35 U.S.C. §119(a)-(d) to DE 10 2016 200 513.8 filed Jan. 18, 2016, which is hereby incorporated by reference in its entirety.

### TECHNICAL FIELD

The disclosure relates to a method and a device for operating a motor vehicle.

### BACKGROUND

Automated driving is increasingly becoming the focal point of the development of future vehicles. In this connection, provision is made that a vehicle being operated in the automated driving mode takes over functions or carries out maneuvers that are usually under the control of the driver. However, a vehicle being operated in the automated driving mode cannot take over all functions or cover all possible situations. Accordingly, under certain conditions the driver has to take back control of the vehicle.

In this connection the problem arises in practice that the driver of a vehicle moving along in completely automated manner is, as a rule, not really concentrating on the driving process (inclusive of the state of the vehicle, the environment of the vehicle, objects present in the environment, the position of the vehicle etc.) but is, for example, indulging in some other activity while the control of the vehicle is completely subject to the automated system.

From DE 10 2014 218 526 A1 a system and a method, among other things, are known, with which the autonomous operation of the vehicle is modified and, where appropriate, terminated on the basis of a change of position of a steering device, of an accelerator or of a brake.

From US 2014/0303827 A1, systems and methods, among other things, are known, with which, on the basis of a determination of the state of the vehicle, a strategy for transferring the control of the vehicle from the automated driving mode to the manual driving mode is ascertained and appropriate instructions for the transition from the automated driving mode to the manual driving mode are generated.

### SUMMARY

It is an object of the present disclosure to make available a method and a device for operating a motor vehicle that enable an enhanced flexibility of the driver in the automated driving mode while guaranteeing an operation that is safe overall.

A method for operating a motor vehicle, said vehicle exhibiting a first driving mode in which an at least partial automation of the control of the vehicle obtains, and said vehicle exhibiting a second driving mode in which this automation has been at least partly canceled and replaced by a manual control of the vehicle on the part of a driver, comprises the following steps:
ascertaining at least one parameter that is characteristic of a current status of the driver; and
adapting a transition strategy for the transition between the first driving mode and the second driving mode in a manner depending on this parameter.

The concept underlying the present disclosure is, in particular, to reactivate the driver or occupant of a vehicle in the automated driving mode, if need be in good time, in a suitable strategy—that is to say, to transfer the control of the vehicle back to said driver.

In embodiments of the disclosure, for this purpose an observation and evaluation of the degree of automation of the vehicle, of the environment, and of the attentiveness or distractedness of the driver take place, wherein in each instance an assessment of the overall situation (in particular, taking the driver, the vehicle, the surroundings of the vehicle and the traffic conditions into consideration) may take place.

By virtue of the disclosure, the possibility is created for the driver, in particular, to occupy himself/herself otherwise during an operation of his/her vehicle in the automated driving mode (in that he/she can, for example, turn his/her attention away from vehicle-control equipment such as the steering wheel or the pedals or can direct his/her attention toward another position within the vehicle).

According to an embodiment, the ascertaining of the at least one parameter includes the ascertaining of a current seat position of the driver in the vehicle and/or the ascertaining of a current activity of the driver.

According to an embodiment, the adapting of the transition strategy for the transition between the first driving mode and the second driving mode takes place, furthermore, in a manner depending on current environmental conditions of the vehicle and/or environmental conditions of the vehicle that are to be expected in future.

According to an embodiment, these environmental conditions include traffic conditions, weather conditions and/or roadway conditions.

According to an embodiment, a further parameter that is characteristic of the complexity of the environment of the vehicle is ascertained on the basis of the environmental conditions.

According to an embodiment, the adapting of the transition strategy for the transition between the first driving mode and the second driving mode takes place furthermore in a manner depending on this further parameter.

According to the disclosure, a prediction of a future state (for example, a complex state as regards the traffic conditions) can be made, in particular, from the current state, wherein the temporal interval to the next complex situation can also be determined. This temporal interval can be compared with the necessary reactivation-time of the driver. So long as the complex situation in question is still temporally or spatially far away, where appropriate a reactivation of the driver may not happen.

According to an embodiment, a prediction of future situations and also time-intervals consequently takes place, in order to guarantee a safe driving operation. In this connection, in particular situations that are difficult or problematic for automated driving can be predicted. Moreover, requisite time-intervals for a renewed transfer of the control to the driver can be predicted.

According to an embodiment, the adapting of the transition strategy or the renewed transfer of the control to the driver includes the communication of a warning signal to the driver, something which may be effected, for example, acoustically or haptically (for example, via a vibration of the seat). Moreover, an automatic transference of the driver's seat into the driving position may take place. Furthermore, any possible entertainment equipment can be deactivated.

According to an embodiment, the adapting of the transition strategy takes place furthermore in a manner depending on a time-interval required for the transition from the first driving mode to the second driving mode. In embodiments, a time-interval for the complete transfer of the control or for the transition from the automated driving mode to the manual operation of the vehicle is ascertained on the basis of the degree of automation and the time-interval up until the deactivation of the automated driving mode.

According to an embodiment, the adapting of the transition strategy includes the definition of a point in time for the beginning of reactivation measures for the purpose of including the driver in the control of the vehicle.

According to an embodiment, these reactivation measures are carried out in such a manner that the control of the vehicle is transferred to the driver stepwise in a manner depending on a monitoring of the status of the driver.

The disclosure further relates to a device for operating a motor vehicle, said vehicle exhibiting an automated driving mode in which the vehicle moves along in automated manner, said device having been configured to implement a method having the features described above.

The definition or prediction of the point in time for an intervention of the driver in the control of the vehicle can take place on the basis of one or more of the following parameters:
environmental complexity (number of traffic signs, number of lanes, number of approach roads or exits, number of parking vehicles etc.);
environmental conditions (weather, roadway, roadworks etc.);
traffic conditions (for example, with regard to the presence of a plurality of moving objects):
degree of distractedness of the driver;
known temporal or spatial limitations of the automated operation of the vehicle, for example driving on a freeway only for a certain distance or the deactivation of the automated driving mode when leaving the freeway, for example on the basis of navigation information. For example, a chain of measures for reactivating the driver can be triggered in appropriately good time if the automated driving mode is intended to be active only when traveling on a freeway and, in view of a predetermined travel route, the relevant or specified freeway exit is known.

In embodiments of the disclosure, assistance functions of the automated driving mode are activated stepwise. In other words, not all the assistance functions have to be switched off immediately, in which connection a lane-keeping assistance system or a cruise-control device, for instance, may remain activated while the fully automated control of the steering wheel is being shut down.

In embodiments of the disclosure, the driver can decide to what degree individual support functions or assistance functions are to be deactivated when he/she takes over the control completely (in that he/she has, for example, his/her hands on the steering wheel, his/her feet on the pedals, and has directed his/her eyes onto the road). In this connection, the driver can also abort the deactivation, in order to maintain a certain degree of support on the part of the vehicle.

Further configurations of the disclosure can be gathered from the description and also from the dependent claims. The disclosure will be elucidated below on the basis of an exemplary embodiment with reference to the appended illustration.

### BRIEF DESCRIPTION OF THE DRAWINGS

The single FIGURE shows a flow diagram for elucidating a possible sequence of the method according to the disclosure in an exemplary embodiment.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

According to the disclosure, the control of a vehicle in the automated driving mode is transferred back to the driver under certain conditions. In this case, in particular the degree of automation of the vehicle, the environment of the vehicle, and the attentiveness of the driver can be monitored and evaluated. In accordance with the disclosure, the transfer of the control of the vehicle to the driver (in the following also designated as “reactivation” of the driver) is subdivided into different aspects.

According to one aspect (steps S10-S12 in the FIGURE), a task to be implemented can be restricted spatially and/or temporally, in that at a certain point in time, or upon reaching a certain position, the driver can be invited to take over the control of the vehicle or, to be more exact, to take renewed manual control of the vehicle. These tasks may be, for example, driving on a freeway, carrying out a parking procedure, leaving a parking zone, driving in a line of vehicles etc.

According to a further aspect (steps S20-S22 in the FIGURE), the complexity of the environment, the environmental conditions and also the traffic conditions can be taken into consideration. For instance, driving in a comparatively complex environment may represent a particular challenge for an automated driving mode, so that the driver has to carry on at least a sort of supervision in order to be able to take over the control of the vehicle again at any time. Moreover, changes in the environment may also influence the capability of the automated driving system and reduce the degree of reliability of the automated driving system. For example, the driver can be informed of a restricted functionality of the automated driving mode if, for example, the vehicle is driving more slowly in a traffic situation with comparatively heavy traffic. In this way, the driver can, in particular, be placed in a position to decide whether he/she is going to take control of the vehicle, in order (for example, by reason of a better recognition of the situation) to be able to drive faster or to leave the current road and choose another route. Moreover, special traffic conditions (for example, tailbacks, accidents, approach of emergency vehicles etc.) are typically not fully registered in the course of automated driving. The driver can also be appropriately informed of such conditions and, if need be, entrusted with the control of the vehicle.

According to an aspect of the disclosure (steps S30-S32 in the FIGURE), in particular the degree of attentiveness or the extent of the distractedness of the driver is monitored. The monitoring of the driver may, for example, show the position or state of the driver (for example, whether the latter is in the normal driving position on the front seat, has turned to face the other occupants of the vehicle from the front seat, or is sleeping on the front seat). Moreover, the activities carried out by the driver can be monitored (for example, whether the driver is presently looking at the scenery, is using his/her tablet computer, or is conducting a conversation with other occupants of the vehicle). All these observations can be taken into consideration in the temporal planning of a renewed inclusion of the driver in the control of the vehicle, or of the transition into the manual driving mode.

All of the aforementioned conditions and observations are ascertained and carried out using the sensors available in the vehicle, and the insights acquired concerning the environment, the vehicle and the driver are combined to create an “observation horizon” in which the complexity of the situation, the temporal and/or spatial limitation of the task to be carried out, the point in time of the renewed inclusion of the driver in the control of the vehicle etc. are predicted.

On the basis of the parameters of the observation horizon, on the one hand, a chain of measures for renewed takeover of the control of the vehicle by the driver can be activated or triggered. Conversely, on the other hand, a complete “uncoupling of the driver” from the task of the control of the vehicle can be prevented where appropriate, for instance by reason of a high traffic density or a high complexity of the environment.

In accordance with the disclosure, in particular a prediction of the requisite steps of the driver can consequently be made on the basis of the parameters of the observation horizon. If the measures of the driver do not become necessary within the observation horizon but, for example, only after the end of the planned navigation route, this can be regarded as a “green” or cleared situation (which does not require an inclusion of the driver in the control of the vehicle). However, if steps of the driver become necessary within the observation horizon, the device calculates the point in time at which the driver is again to be in a position to take over the control of the vehicle. On the basis of this calculation (and also, where appropriate, a safety time-interval), a chain of measures for the purpose of renewed inclusion of the driver in the control of the vehicle is activated (steps S13, S28 and S50 in the FIGURE).

If an immediate or short-term action of the driver is imperative, the conventional chain of measures for renewed inclusion of the driver in the control of the vehicle can be shortened appropriately (steps S23, S24 and S40 in the FIGURE). In this case, the driver can be warned (for example, via different visual, acoustic and/or haptic signals).

In the corresponding chain of measures for renewed inclusion of the driver in the control of the vehicle, the driver is informed in a first step that he/she is to take over the control of the vehicle. This can be effected via an acoustic, visual and/or haptic communication of information to the driver. In this connection, the time up until the takeover of the control can be displayed in the form of a countdown.

In the next step, the driver—or, to be more exact, the driver's seat—can be transferred back into the driving position. In a further step, a wait is observed and the moment when the driver places his/her hands on the steering wheel again and is ready to actuate the foot pedals is monitored. If the hands of the driver are again located on the steering wheel for a certain time-interval Ts, the control of the steering can be transferred back to the driver. Moreover, at the beginning of a steering procedure by the driver the control can be handed over to the driver again.

If the feet of the driver are again located in a suitable position for an actuation of a pedal for a certain time-interval Tf, the longitudinal control of the vehicle—or, to be more exact, the control of the longitudinal motion of the vehicle—can be transferred back to the driver. Moreover, the control can be transferred to the driver as soon as the driver begins to actuate one of the pedals. Subsequently the automated driving mode is shut down.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for changing driving modes while operating a motor vehicle, comprising:
exhibiting a first driving mode defined by an at least partial automation of control of the vehicle;
exhibiting a second driving mode defined by replacing the at least partial automation with a manual control of the vehicle including ascertaining at least one parameter that is characteristic of a current status of a driver to initiate the manual control; and
adapting a transition strategy for a transition between the first driving mode and the second driving mode in a manner based on the at least one parameter.

2. The method as claimed in claim 1, wherein the ascertaining of the at least one parameter includes ascertaining of a current driver seat position in the vehicle and the ascertaining of a current driver activity.

3. The method as claimed in claim 1, wherein the adapting of the transition strategy for the transition between the first driving mode and the second driving mode occurs in a manner depending on current vehicle environmental conditions and expected vehicle environmental conditions.

4. The method as claimed in claim 3, wherein the vehicle environmental conditions and the expected vehicle environmental conditions include traffic conditions, weather conditions or roadway conditions.

5. The method as claimed in claim 3 further comprising ascertaining a further parameter characteristic of a complexity of the vehicle environmental conditions.

6. The method as claimed in claim 5, wherein the adapting of the transition strategy for the transition between the first driving mode and the second driving mode depends on the further parameter.

7. The method as claimed in claim 1 further comprising communicating a warning signal to the driver to indicate the adapting of the transition strategy.

8. The method as claimed in claim 1, wherein the adapting of the transition strategy depends on a time-interval required for the transition from the first driving mode to the second driving mode.

9. The method as claimed in claim 1 further comprising defining a point in time for a beginning of reactivation measures to include the driver in the manual control of the vehicle during the adapting of the transition strategy.

10. The method as claimed in claim 9, wherein the reactivation measures occur such that control of the vehicle is transferred to the driver in a stepwise manner depending on the current status of the driver.

11. An automated driving system for a motor vehicle, comprising:
a device configured to, in response to a parameter indicative of a current driver status while operating in a first driving mode defined by a partial automation of the vehicle, adapt a transition strategy based on the parameter to switch from the first driving mode to a second driving mode, the second driving mode defined by manual control of the vehicle.

12. The automated driving system as claimed in claim 11, wherein the device is further configured to output a warning signal when transitioning from the first driving mode to the second driving mode.

13. The automated driving system as claimed in claim 11, wherein the parameter is a driver seat being in a non-driving position.

14. The automated driving system as claimed in claim 13, wherein the device is further configured to move the driver seat from the non-driving position to a driving position when transitioning from the first driving mode to the second driving mode.

15. The automated driving system as claimed in claim 11, wherein the device is further configured to adapt the transition strategy based on environmental conditions.

16. A vehicle comprising:
a plurality of sensors configured to obtain data indicative of a vehicle environment, traffic conditions and attentiveness of a driver;
a driver seat configured to move between a non-driving position and a driving position; and
a device configured to, in response to the data from the sensors indicating an observation horizon specifying a point in time of renewed inclusion of the driver in control of the vehicle, adjust the driver seat from the non-driving position to the driving position such that manual driving control is initiated.

17. The vehicle as claimed in claim 16, wherein the device is further configured to adjust the driver seat within a time-interval required for a transition from a first driving mode defined by at least a partial automation to a second driving mode defined by manual operation.

18. The vehicle as claimed in claim 17, wherein the device is further configured to output a warning signal before the transition from the first driving mode to the second driving mode.

19. The vehicle as claimed in claim 18, wherein the warning signal includes an audible warning.

20. The vehicle as claimed in claim 17, wherein the transition from the first driving mode to the second driving mode occurs stepwise based on the data indicative of the attentiveness of the driver.
